(19) United States
(12) Patent Application Publication
(10) Pub. No.: US 2021/0374636 A1
(43) Pub. Date: Dec. 2, 2021

(54) SYSTEM AND METHOD FOR CLOUD-BASED MEDIA MANAGEMENT

(71) Applicant: NCR Corporation, Duluth, GA (US)

(72) Inventor: Edgar Rojas, Weston, FL (US)

(21) Appl. No.: 16/883,303

(22) Filed: May 26, 2020

(51) Int. Cl. G06Q 10/06; G06Q 10/08; G06Q 10/04; G06Q 20/18; G06Q 20/20; G06Q 20/10

(52) U.S. Cl. CPC G06Q 10/06312; G06Q 10/0838; G06Q 10/087; G06Q 20/1085; G06Q 20/18; G06Q 10/0833; G06Q 20/202; G06Q 10/047

(57) ABSTRACT

A system and method for managing media replenishment of media terminals is disclosed. The system includes a plurality of media terminals within separate groups of networks which are coupled to a media manager via a wide area network. An agent may be installed at each media terminal. The agent forwards status information about media at each associated media terminal to the media manager via the wide area network. The media manager generates an initial delivery schedule for each media terminal based on accumulated historical device data and initial rules, processes status information for each media terminal received via the wide area network and optimizes a prior delivery schedule for each media terminal based on such received status information to generate an updated delivery schedule for that media terminal, and provides the updated delivery schedule to an administrator for that associated media terminal.

### FIELD

This disclosure relates generally to a system and method for cloud-based media management. In particular, although not exclusively, the invention relates to cloud-based management of replenishment of media in the form of banknotes at a media terminal, such as an automated teller machine (ATM).

### BACKGROUND

ATMs need periodic replenishment so that they can continue to dispense cash (i.e., money in the form of bills and/or coins) to customers. Owners of large ATM networks typically develop and use cash forecasting techniques to ensure that sufficient cash is present throughout a bank's network (which includes the bank's ATMs) to maintain availability of cash and to minimize cash replenishment operations, without requiring large amounts of surplus cash to be located within the network.

In particular, each owner of a large ATM network develops, installs, and maintains a cash forecasting system which generates recommended scheduled visits and recommended replenishment amounts based on business rules provided to the cash forecasting system. Which rules are supported and how they are implemented is one of the key differentiators between cash forecasting solutions. A cash forecasting system is typically aware of the forecasted cash demand, current scheduled replenishment visits, and current scheduled replenishment amounts. The cash forecasting system is sometimes combined with an ATM management system that, inter alia, operates to address any unforeseen events (for example, nearby ATMs being out of service or an un-forecasted local event that drives a higher-than-normal need for cash in the area) by ordering an extra cash dispatch to ensure that the ATM is able to remain in service.

However, such combined forecasting/management systems require capital investment to install, require extensive development work to configure, and require dedicated employees to operate. Accordingly, there is a need for a media management system and method which addresses such drawbacks.

### BRIEF DESCRIPTION OF THE DRAWINGS

The following detailed description, given by way of example and not intended to limit the present disclosure solely thereto, will best be understood in conjunction with the accompanying drawings in which:

FIG. 1 is a simplified block diagram of a cloud-based media management system according to an aspect of the present disclosure;

FIG. 2 is a block diagram of a cloud-based media manager according to an aspect of the present disclosure; and

FIG. 3 is a flowchart of a cloud-based media management method according to another aspect of the present disclosure.

### DETAILED DESCRIPTION

In the present disclosure, like reference numbers refer to like elements throughout the drawings, which illustrate various exemplary embodiments of the present disclosure. The present disclosure describes a media management system for use in managing the amount of cash (as an example type of media) present at devices (such as ATMs and other cash-handling devices used in the banking industry) within a group of separate networks (such as an ATM network operated by a bank).

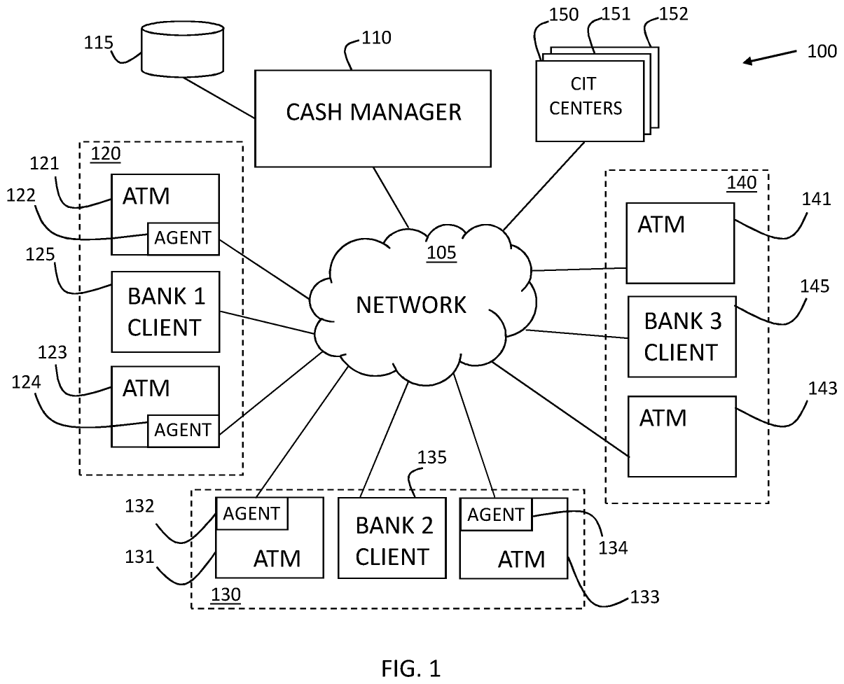

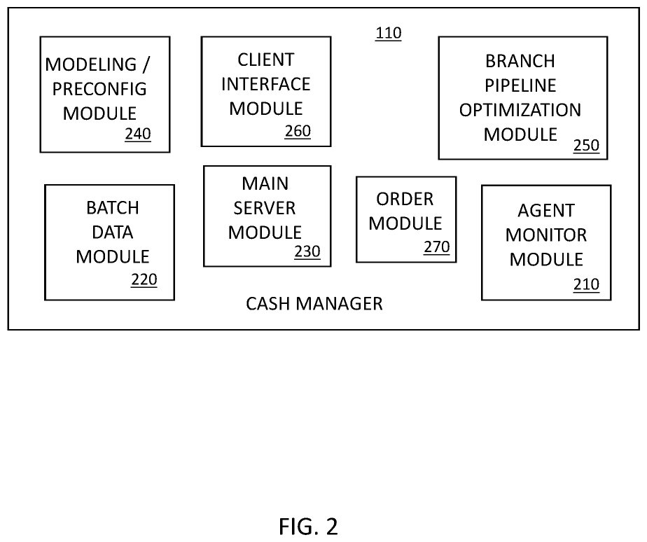

Referring now to FIG. 1, a cloud-based media management system 100 is shown, here specifically applied to managing cash flow in a number of different ATM networks 120, 130, 140. As will be appreciated by those of ordinary skill in the art, the cloud-based media management system 100 may be used to manage other types of networks where other types of media are stored and distributed. Each ATM network 120, 130, 140 is a local network which may be owned by a separate bank (although in other cases the separate networks may be commonly owned but, for example, geographically separated), with ATM network 120, 130, 140 requiring a subscription for access to cash (media) manager 110. Cash manager 110 is connected to a network 105 (e.g., a wide area network such as the Internet) and also to a database 115 for maintaining updated status information for each ATM or other device in each ATM network which maintains a supply of cash (e.g., a recycler, depositor, locker, etc.). The operation of cash manager 110 is discussed below with respect to FIG. 2. The cloud-based media management system 100 provides a number of benefits over prior (locally installed) solutions, which required, inter alia, dedicated servers on the local network and, in advance of installation, custom configuration and data modelling. In particular, each ATM network owner (i.e., bank) is able to obtain intelligent cash management without any capital investment or any expensive and time-consuming internal data integration development work. Furthermore, each ATM network owner is able to provide intelligent cash management to its customers in a simplified manner, without reliance on each bank's infrastructure teams in separately managing data integration for each installation.

Each of the different ATM networks 120, 130, 140 includes a number of ATMs or other devices used to store and/or distribute cash (collectively “media terminals”) and at least one client computer for accessing information from cash manager 110. In particular, as shown in FIG. 1, ATM network 120 owned by Bank 1 (i.e., a first ATM network owner) includes two ATMs 121, 123 and a client computer 125. Similarly, ATM network 130 owned by Bank 2 (i.e., a second ATM network owner) includes two ATMs 131, 133 and a client computer 135 and ATM network 140 owned by Bank 3 (i.e., a third ATM network owner) includes two ATMs 141, 143 and a client computer 145. As readily recognizable, each bank's ATM network is separately administered and typically includes many more ATMs and other devices and have more than one client computer for accessing information from cash manager 110, but for purposes of the present disclosure, two ATMs and a single client computer allows the system and method of the present disclosure to be understood. In addition, each bank may administer a plurality of ATM networks, each separately subscribing to cash manager 110. Each client computer 125, 135, 145 is coupled to cash manager 110 via network 105. For banks 1 and 2, each of the ATMs 121, 123, 131, 133 has a respective associated agent 122, 124, 132, 134 installed to monitor the status of the associated ATM 121, 123, 131, 133, including, inter alia, cash data by components (e.g., currency cassettes) and cash-in-transit (“CIT”) transaction information, and uploads such status information to cash manager 110 at either regular intervals or in real time, via network 105. In some cases, it may not be possible to install an agent in a bank's ATMs (or other devices). This is shown in FIG. 1 by ATM network 140 owned by bank 3, where each ATM 141, 143 does not include any agent. In this case, flat files containing all the status information for a particular cycle are regularly uploaded to cash manager 110 by bank personnel via client computer 145 and network 105.

Each of the ATM networks 120, 130, 140 has a relationship with an associated CIT (or media storage and delivery) center 150, 151, 152 which stores and delivers currency to the various ATMs and other devices in each ATM network, based either on a regular schedule or based on replenishment requests (e.g., when the cash supply for one or more currency cassettes at a particular ATM run low). Each CIT center 150, 151, 152 is also coupled to cash manager 110 via network 105.

As evident, no local servers are required to host the applications that run on cash manager 110 at each ATM network for the system 100 shown in FIG. 1, significantly reducing the capital and development costs necessary to access cash manager 100.

Referring now to FIG. 2, cash manager 110 includes an agent monitor module 210, a batch data module 220, a main server module 230, a modeling/pre-configuration module 240, and a branch (ATM network) pipeline optimization module 250. Cash manager 110 automatically forecasts and tunes the data to produce optimized (updated) delivery schedules for each of the ATMs based on optimizing a prior delivery schedule (e.g., the initial delivery schedule or a previously updated delivery schedule) and related devices in the network. Cash manager 110 provides true multi-tenant support and a service-based architecture that provides superior scalability via parallel processing. Cash manager 110 eliminates the need for cash analysts to operate, manage, and drive a number of processes that are now automatic and embedded in the operation of cash manager 110. Cash manager 110 provides a real-time decision support tool that goes beyond a reactive approach for ATM (and recycler etc.) networks. Cash manager 110 preferably has a direct interface via network 105 with the each agent (e.g., agents 122, 124, 132, 134) in order to capture centralized cash data by components and CIT transaction information (Deliveries and Returns) in real time. Cash manager 110 predicts a demand for currency at each cash point on an individual basis. By applying sophisticated mathematical algorithms to historical, event and cost data, cash manager 110 determines an optimal cash position and delivery schedule for each device. Using cash manager 110, service requests can be triggered by capacity constraints, cost constraints, denomination constraints. Cash manager 110 forecasts by denomination and quantity thereby providing improved options to optimize cash allotments. Cash manager 110 also forecasts by component and by denomination (e.g., by notes and/or coins).

Cash manager 110 provides, inter alia, intraday data by denomination and component; effective alters based on accumulated predicted demand or basic balance comparison against required balances calculated by main server module 230; the identification situations of excesses cash; an improved decision-making process around emergencies and exception; reduction of possible out of cash situations or device out of service situations; a reduction in transportation costs incurred in unnecessary emergencies or deliveries; simulations to determine the best device configuration (data analytics); and a more pre-emptive process to manage exceptions instead of a reactive generation of emergency cash.

Cash manager 110 stores device actual transactions and balances by currency and cassette and device predicted demand and estimated balances by cycle in database 115. Cash manager 110 has a pre-emptive alter process against estimated balances or calculated required balances. Cash manager 110 analyzes demands by cycle or allow the implementation or rules to manage the exceptions. Cash manager 110 reports device balances and accumulated demand by cassette and cycle, graphically and by list, using several available reports. As further explained below, cash manager 110 provides a user friendly user interface via client interface module 260 that reports, inter alia, alters and exceptions by device. Cash manager 110 reports on opportunities to recycle cash within the devices.

Agent monitor module 210 receives intraday data from each agent in each ATM or other device (e.g., agents 122, 124, 132, 134 in respective ATMs 121, 123, 131, 133 in FIG. 1), formats the data and transfers the formatted data to the main server module 230 for processing and storage in database 115. Agent monitor module 210 is in direct and real time communication with each agent. The information from each agent preferably includes data for each device organized by denomination and component, and agent monitor module 210 will preferably validate the data upon receipt.

Batch data module 220 receives flat data files from clients at ATM networks which do not include agents installed at each ATM or other device (e.g., from bank 3 client 145 in FIG. 1). The received flat data files include intraday data for each ATM or other device by cycle. Batch data module 230 may format the data, if necessary, and then transfers such data to the main server module 230 for processing and storage in database 115.

Main server module 230 is configured with a definition of cycle and how demand will be accumulated for each device within each ATM network. Main server module 230 uses accumulated demand to determine a percentage of withdrawals dispensed by cycle and by day of the week as well as total withdrawals per cycle to produce a main forecast for each device within each ATM network. Once a cycle cutoff time is defined, main server module 230 extracts either the balance transmitted from the agent or the balance reported from the host for any given device. Main server module 230 uses this balance as a point of reference to determine how close a previously calculated balance is in reference to the actual reported for forecasting purposes. With this optimized forecast provided via the client interface module 260, each bank is able to manage exceptions in a more intelligent way and move from a reactive to a pre-emptive approach. The user of cash manager 110 can reduce operational issues in the ATM network—avoiding unnecessary emergency services or deliveries when cash manager 110 identifies that an excess cash situation exists prior to the arrival of a cash-in-transit delivery or situations where overfill cassettes reach capacity and turn off the device. Cash manager 110 tracks data on a component level within each device, which forecast, optimization and alerts at that component level.

Modeling/pre-configuration module 240 is used to generate the initial data models and to configure each ATM network and the various devices in each ATM network. Modeling/pre-configuration module 240 receives accumulated historical device data for a period of time (when available) and initial business rules (initial rules), and analyzes such data to identify an initial optimal configuration (e.g., an initial delivery schedule) for each device.

Branch pipeline optimization module 250 provides cash optimization of cash deliveries and returns for an ATM network, optimization of cash movements between cash vaults and devices, optimization of cash movements within devices, and status information and alerts for all the ATM network devices.

Client interface module 260 provides a user interface (dashboard) for each bank via a client computer (e.g., client computers 125, 135, 145 in FIG. 1) so that a bank administrator for that bank can access cash manager 110 to upload flat files, if necessary, to access a dashboard for the associated ATM network, to obtain updated delivery schedules, and for other configuration purposes (e.g., to access modeling/pre-configuration module 240). Client interface module 260 is coupled to branch pipeline optimization module 250 to receive information to be included on the dashboard (user interface), including, inter alia, daily exceptions and alerts, forecast information, cash level by device, cash vault level within the network, network and device performance. CIT cost, opportunity cost, and/or cash processing cost. Each bank which subscribes to cash manager 110 thus has access to the exceptions produced via the client interface. Using the client interface, bank employees may interact with an order module 270 to create any necessary emergency orders or actions by an associated CIT center required due to unexpected events affecting the status of any of the devices within the ATM network. Order module 270 is coupled to CIT centers 150, 151, 152 in FIG. 1 via network 105. The dashboard shows the status and current balance state of each device in the ATM network. In addition, the dashboard provides a recommendation of cash movements within a device and within the network. Via the dashboard, an analyst is able to review the last load date and time for each device in the dashboard, and see cycle details by denomination and cassettes by date for each device. The dashboard also provides a visualization of the current balance of every device in the ATM network. In addition, the dashboard allows each bank to see cycle data, status, and alerts for each device in the ATM network, along with ordering information including status and device detail information, forecast, etc.

Cash manager 110 produces orders that are transmitted to associated CIT centers and to the device (ATM). and deliveries are confirmed by the agent at each device, by date, time, and amount by denomination. Cash manager 110 also provides different alters and alerts. Operational alters inform a bank that an action needs to be taken on an existing order or to trigger a new one to manage an exception. Device status alerts inform the bank about the state of a device, and trigger different actions in coordination with each respective device monitoring team.

Cash manager 110 provides business intelligence and pre-configuration by accumulating daily information and, based on cost and other factors, recommending an optimum best configuration to reduce cost or operational exceptions by adding more cassettes, changing denominations, etc.

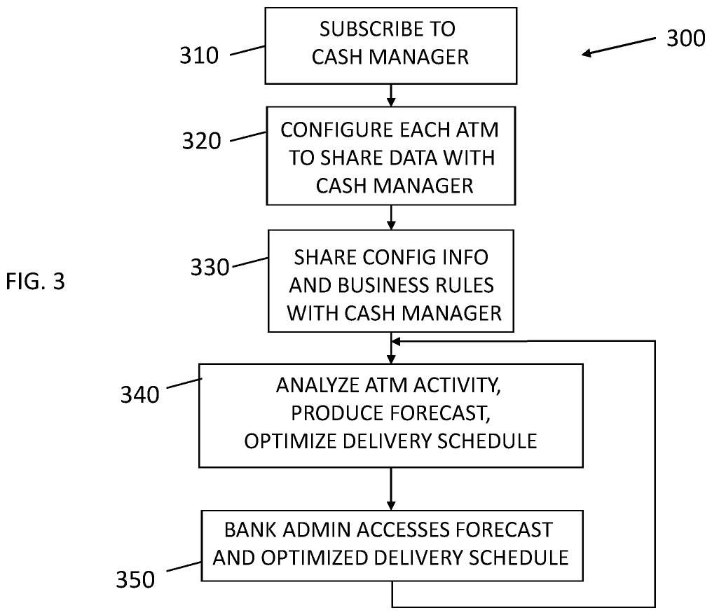

Referring now to FIG. 3, a flowchart 300 is shown describing the operation of cash manager 110. First, at step 310, each bank subscribes to cash manager. Next, at step 320, each ATM or other device in the bank's ATM network is configured to share data with the cash manager, e.g., via an agent installed at each device within the ATM network. Alternatively, as discussed above, if it is not possible to install an agent at every device, bank personnel will upload data on a regular basis to cash manager for each such device. Further, at step 330, configuration information and business rules are uploaded (shared) with cash manager. Still further, cash manager analyzes ATM (device) activity and produces forecasts and optimized (updated) delivery schedules for each device at step 340. Finally, a bank can then access the forecast and optimized (updated) delivery schedules via a cloud-based network connection (step 350). The optimized delivery schedules may also be provided to the CIT center directly at step 350. Steps 340 and 350 continue in a loop once the ATM network is deployed.

Although the present disclosure has been particularly shown and described with reference to the preferred embodiments and various aspects thereof, it will be appreciated by those of ordinary skill in the art that various changes and modifications may be made without departing from the spirit and scope of the disclosure. In particular, although the present disclosure is addressed to a system and method for employing a cash manager that manages the amount of cash at devices within each network among a group of separately administered networks, it will be appreciated by those of ordinary skill in the art that such system and method has broad application to managing any type of media distributed in a similar manner. It is intended that the appended claims be interpreted as including the embodiments described herein, the alternatives mentioned above, and all equivalents thereto.

1. A method of managing media replenishment of a plurality of media terminals within one or more separate groups of networks, the method comprising the steps of:
providing accumulated historical device data and initial rules for each media terminal to a media manager via an Internet connection;
generating an initial delivery schedule for each media terminal based on the accumulated historical device data and initial rules;
receiving status information about media at the media terminal via the Internet connection;
processing the received status information and optimizing a prior delivery schedule for each media terminal based on such received status information to generate an updated delivery schedule for that media terminal; and
providing the updated delivery schedule to an administrator for that media terminal.

2. The method of claim 1, further comprising the step of:
installing an agent at each media terminal, the agent configured to forward status information about media at the media terminal to the media manager via the Internet connection.

3. The method of claim 2, wherein the updated delivery schedule is provided to the administrator for the associated media terminal via the agent at that media terminal.

4. The method of claim 1, wherein the status information about media at the media terminal is received in batch form at regular intervals.

5. The method of claim 1, further comprising the step of providing the updated delivery schedule to a media storage and delivery center associated with the respective media terminal.

6. The method of claim 1, wherein the updated delivery schedule is provided to the administrator for the associated media terminal via a client interface.

7. The method of claim 1, further comprising the step of storing the status information about media at the media terminal received via the Internet connection in a database.

8. The method of claim 1, further comprising the step of providing a dashboard display for each group of media terminals via a client interface, the dashboard display providing a visual indication of one or more of the following: daily exceptions and alerts, forecast information, media level by device, media vault level within the group, group and device performance. media delivery cost, opportunity cost, and media processing cost.

9. The method of claim 1, wherein the plurality of media terminals are within at least two separate groups of networks and each separate group of networks is separately administered.

10. A system of managing media replenishment of media terminals, comprising:
a plurality of media terminals within one or more separate groups of networks; and
a media manager coupled to the plurality of media terminals via an Internet connection, the media manager configured to:
generate an initial delivery schedule for each media terminal based on accumulated historical device data and initial rules for that media terminal;
process status information for each media terminal received via the Internet connection and optimize a prior delivery schedule for each media terminal based on such received status information to generate an updated delivery schedule for that media terminal; and
provide the updated delivery schedule to an administrator for that associated media terminal.

11. The system of claim 10, further comprising:
an agent installed at each media terminal, the agent configured to forward status information about media at an associated media terminal to the media manager via the Internet connection.

12. The system of claim 11, wherein the media manager is configured to provide the updated delivery schedule to the administrator for the associated media terminal via the agent at that media terminal.

13. The system of claim 10, wherein the status information about media at the media terminal is received at the media manager in batch form at regular intervals.

14. The system of claim 10, wherein the media manager is configured to provide the updated delivery schedule to a media storage and delivery center associated with the respective media terminal.

15. The system of claim 10, wherein the media manager is configured to provide a client interface and the updated delivery schedule is provided to the administrator for the associated media terminal via the client interface.

16. The system of claim 10, wherein the media manager is configured to provide a client interface and a dashboard display for each group of media terminals via the client interface, the dashboard display providing a visual indication of one or more of the following: daily exceptions and alerts, forecast information, media level by device, media vault level within the group, group and device performance. media delivery cost, opportunity cost, and media processing cost.

17. The system of claim 10, further comprising a database coupled to the media manager, and wherein media manager is configured to store the status information about media at the media terminal received via the Internet connection in the database.

18. The system of claim 10, wherein the plurality of media terminals are within at least two separate groups of networks and each separate group of networks is separately administered.

19. A system of managing media replenishment of media terminals, comprising:
a plurality of media terminals within separate groups of networks, each separate group of networks separately administered; and
a media manager coupled to the plurality of media terminals via an Internet connection, the media manager configured to:
generate an initial delivery schedule for each media terminal based on accumulated historical device data and initial rules for that media terminal;
process status information for each media terminal received via the Internet connection and optimize a prior delivery schedule for each media terminal based on such received status information to generate an updated delivery schedule for that media terminal; and
provide the updated delivery schedule to a media storage and delivery center associated with the respective media terminal.

20. The system of claim 19, further comprising:
an agent installed at each media terminal, the agent configured to forward status information about media at an associated media terminal to the media manager via the Internet connection.
